(19) United States
(12) Patent Application Publication
(10) Pub. No.: US 2005/0279894 A1
(43) Pub. Date: Dec. 22, 2005

(54) Locking base for display hook

(76) Inventors: Nicholas M. Sedon, Weddington, NC (US); David K. Huehner, Cuyahoga Falls, OH (US)

Correspondence Address: SAND & SEBOLT, AEGIS TOWER, SUITE 1100, 4940 MUNSON STREET, NW, CANTON, OH, 44718-3615, US

(21) Appl. No.: 10/977,744

(22) Filed: Oct. 29, 2004

Related U.S. Application Data
(60) Provisional application No. 60/519,556, filed on Nov. 12, 2003.

(51) Int. Cl. F16M 11/00; F21V 21/00

(52) U.S. Cl. 248/175

(57) ABSTRACT

A lockable base for locking a rod assembly to a display board includes two portions which lock together. A pair of pivotable arms is mounted on one of the portions and pivot into a space between the display board and a hook of the rod assembly. The other portion includes a stop to prevent the arms from pivoting. Alternately, in a second lockable base, each portion thereof includes a pair of spaced rigid arms which slide into the space between the display board and hook. Alternately, a third lockable base is used with a rod assembly having a rod with a stop. One portion of the third base defines a slot for slidably receiving a portion of the rod between the display board and the stop on the rod. The one portion further includes a wall stepped inwardly from another wall and insertable in the interior chamber of the other portion.

### CROSS-REFERENCE TO RELATED APPLICATIONS

This application contains the benefit of Provisional Application Ser. No. 60/519,556, filed Nov. 12, 2003; the contents of which are incorporated herein by reference.

### BACKGROUND OF THE INVENTION

1. Technical Field

The present invention relates generally to merchandise display hooks that are attached to a support structure such as a display board or a wire display rack. More particularly, the present invention relates to display hooks that either prevent the rapid removal of items of merchandise from the display hook or prevent removal of items of merchandise when the display hook is locked. Specifically, the present invention relates to display hooks that can be locked to a display board or wire rack to prevent the removal of the display hook from the display rack.

2. Background Information

Items of merchandise are commonly displayed for sale on long protruding rods supported from pegboard or slatboard. These protruding rods are commonly referred to in the art as pegboard hooks or slatboard hooks. Similar rods may also protrude from a wire display rack for the same purpose. Usually, the items of merchandise are of a smaller range, such as batteries or small tools or other components. Such merchandise is an easy target for shoplifters for several reasons. One way that shoplifters can rapidly remove items from a store involves taking the entire display hook with the merchandise thereon off of pegboard and the like if they are not locked thereon. Therefore, it is desired in the art to provide security hooks that prevent the removal of the display hooks from the pegboards or wire racks.

### BRIEF SUMMARY OF THE INVENTION

The invention provides a locking base for a display rod that is used to display items of merchandise from a support structure. The locking base locks a locking hook to the support structure and prevents unauthorized access to the hook.

Another feature of the invention is to provide a locking base in which a pair of members are pivotally or slidably joined together and secured in a locked position by a magnetically operated lock mechanism.

A further feature of the invention is to provide the locking base with pivotally mounted levers which move into spaces formed between a lock bar of the locking hook and the support structure when in the locked position to prevent removal of the display rod from the support structure.

A still other aspect of the invention is to provide a portion of the locking base with rigid ribs which extend into the space formed between the lock bar and support structure when in the locked position to prevent unauthorized removal of the display rod from the support structure.

Still another feature of the invention is to provide the lock hook with a pair of legs which extends through openings formed in the support structure and with a generally horizontally extending lock bar for receiving a bent end of the display rod which is locked thereon by levers and rigid ribs formed on first and second portions of the locking base, which portions are locked together to form the locking base.

Another aspect of the present invention is to form one of the locking base portions with an elongated slot which is slid over and into a reduced diameter portion of the display rod which prevents removal of the display rod from the locking base when the second portion of the locking base is secured to the first portion.

These features are obtained by the improved locking base of the present invention and the combination of the locking base display rod and support surface on which various items of merchandise are displayed for individual removal of the merchandise from the rods while preventing removal of the rod from the supporting structure.

### BRIEF DESCRIPTION OF THE SEVERAL VIEWS OF THE DRAWINGS

FIG. 1 is a side elevational view of a first embodiment of the lockable base of the present invention shown locking a display hook to a pegboard, with items of merchandise hanging from the display hook.

FIG. 2 is a sectional view of the lower half of the lockable base as it moves toward the pegboard toward a locked position, as seen from the same perspective as FIG. 1.

FIG. 3 is a sectional view taken from the same perspective as FIG. 2 but showing the upper half and lower half of the base hook in a locked position.

FIG. 4 is a rear elevational view of first embodiment taken on line 4-4 of FIG. 3.

FIG. 5 is a front elevational view of a second embodiment of the present invention showing a lockable base in an open position.

FIG. 6 is an elevational view of the second embodiment in the closed and locked position.

FIG. 7 is a sectional view of the second embodiment taken from the side.

FIG. 8 is a rear elevational view of the second embodiment taken on line 8-8 of FIG. 7.

FIG. 9 is a front elevational view of a third embodiment of the present invention showing a locking base in two separate pieces with the lower portion moving towards a locked position.

FIG. 10 is a front elevational view of the third embodiment in a locked position with a portion of the front wall cut away to show a sectional view of the locking mechanism.

FIG. 11 is a sectional view taken from the side of the third embodiment.

Similar numerals refer to similar parts throughout the drawings.

### DETAILED DESCRIPTION OF THE INVENTION

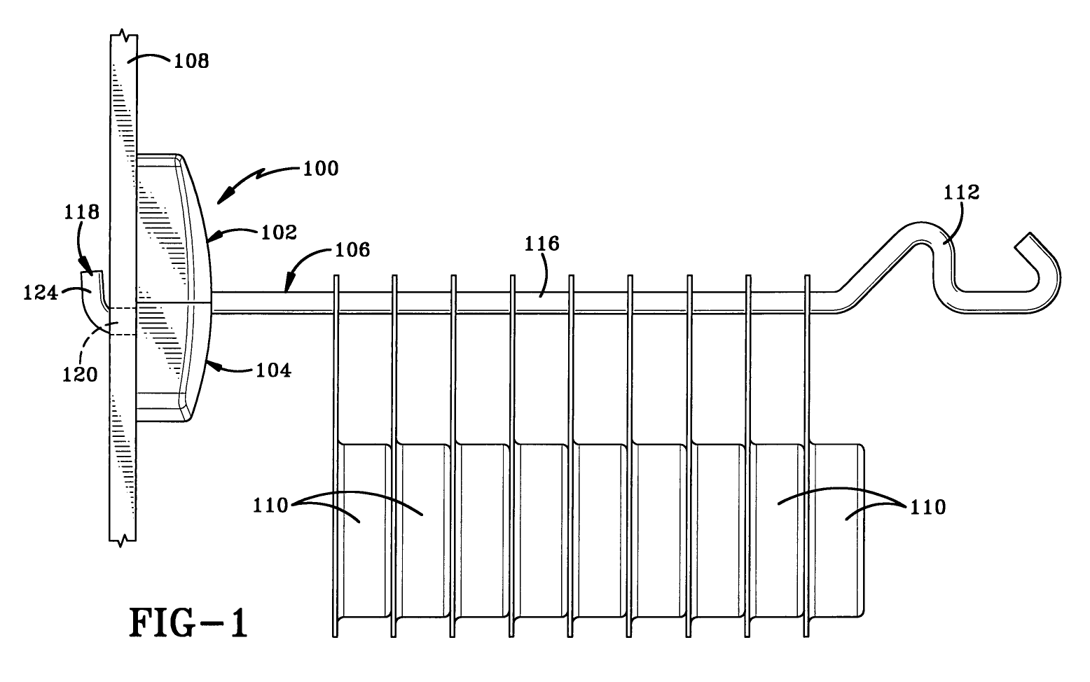

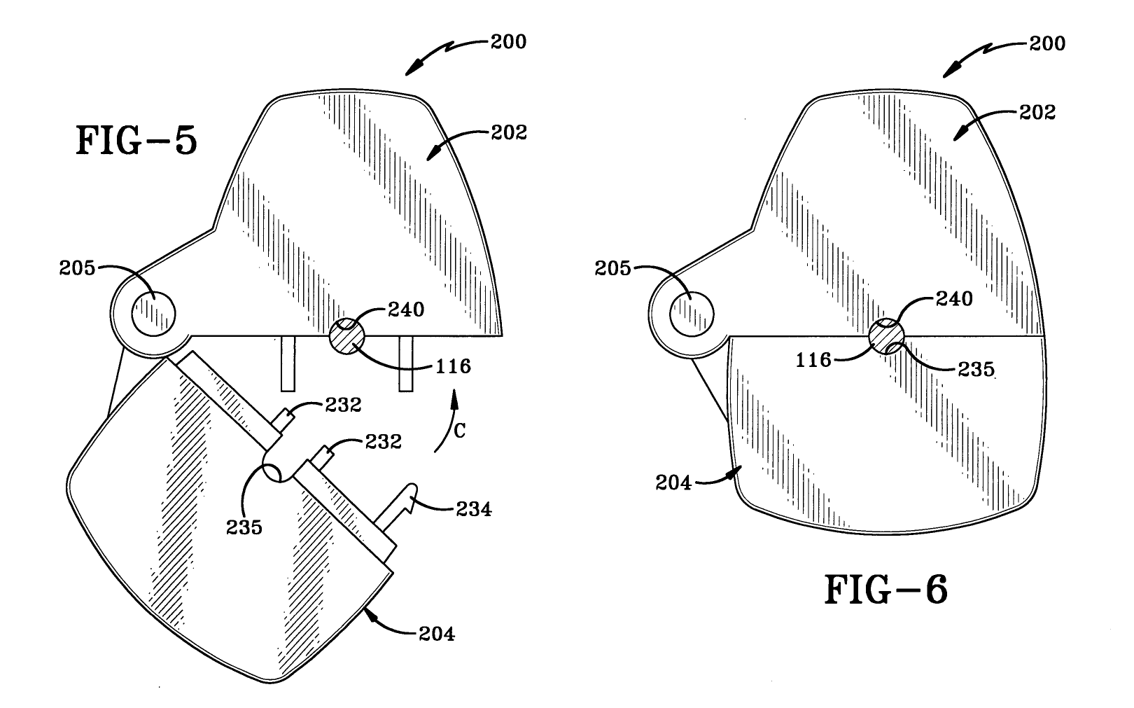

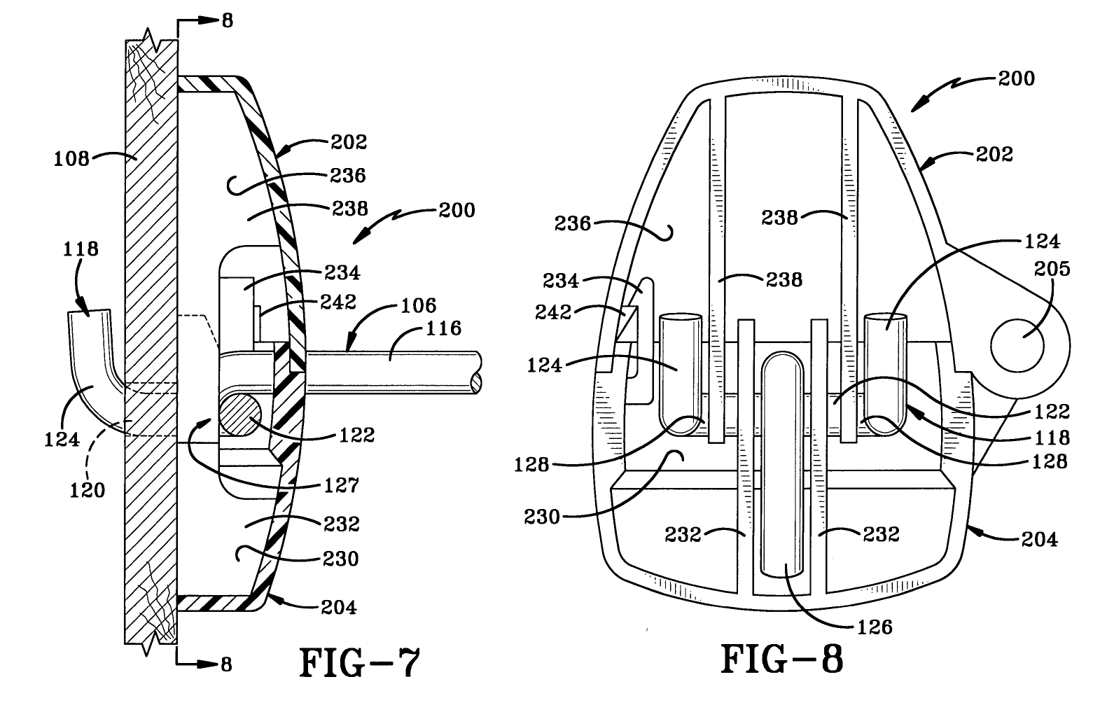

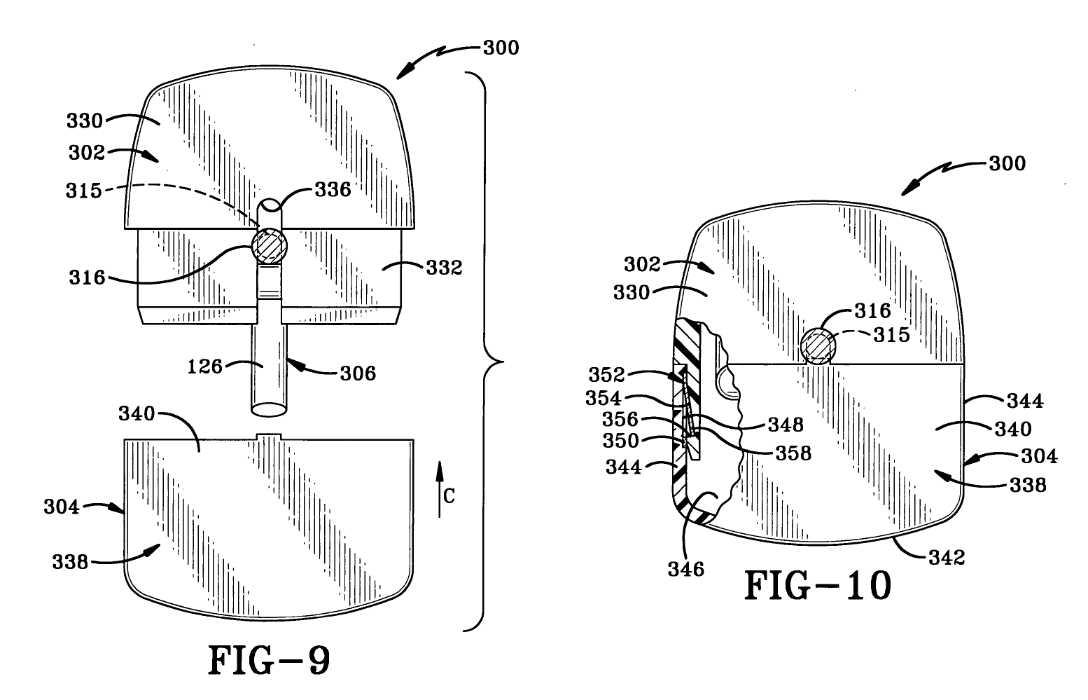

The lockable base of the present invention is shown in three embodiments, the first embodiment being indicated at generally by the numeral 100 in FIGS. 1-4, the second embodiment being indicated generally by the numeral 200 in FIGS. 5-8, and the third embodiment being indicated generally by the numeral 300 in FIGS. 9-11. In this application, the term “locked” is defined as a condition that requires a key to change the condition from locked to unlocked. A locked connection is thus more secure than a latched condition.

Lockable base 100 includes an upper portion 102 and a lower portion 104 which when joined form an interior chamber 125, and lock together to lock a rod assembly 106 to a support structure 108, whereby items of merchandise 110 are hung from rod assembly 106. Rod assembly 106 may be a straight rod. Rod assembly 106 may also include an outer end 112 configured to prevent rapid removal of items 110 therefrom. Rod assembly further has an inner end 114 configured to connect to support structure 108. Rod assembly 106 includes rod 116 that is rigidly mounted to a hook 118. Hook 118 mounts rod assembly 106 to support structure 108. Hook 118 includes a lock bar 122 and a pair of hook ends or legs 124 which extend from the ends of lock bar 122 and extend through holes formed in the support structure and in an upward direction when the rod assembly is connected to support structure 108. The inner end of rod 116 includes a downwardly bent finger 126 which passes between hook ends 124 and through a space 127 formed between lock bar 122 and the outer surface of support structure 108 and rests against support structure 108.

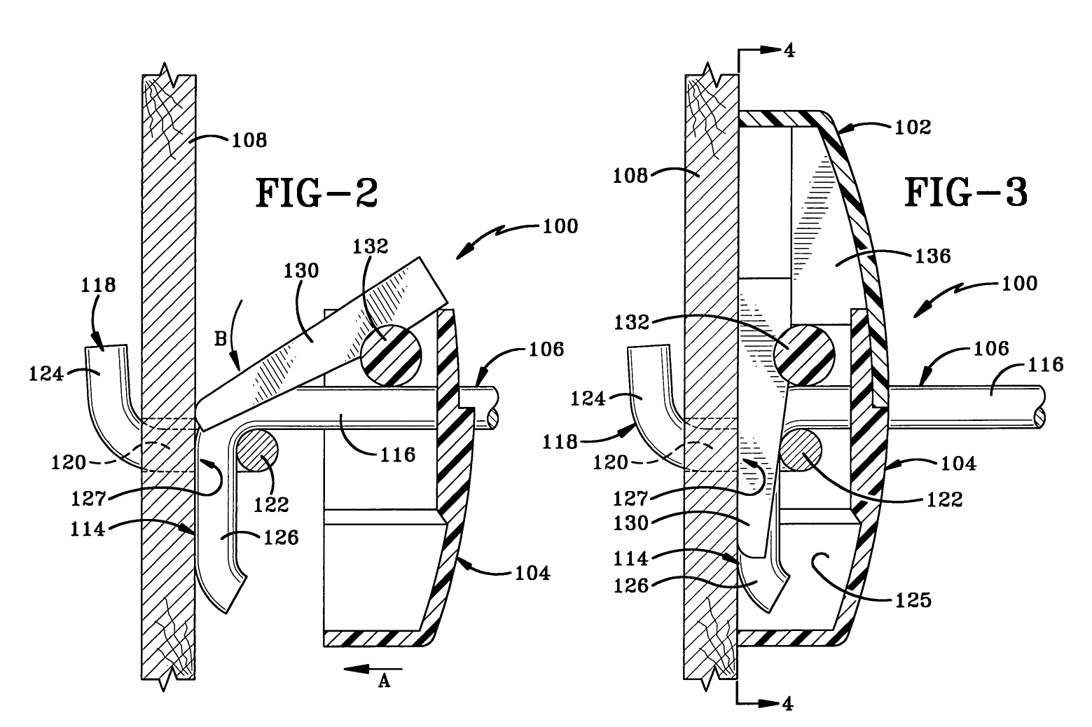

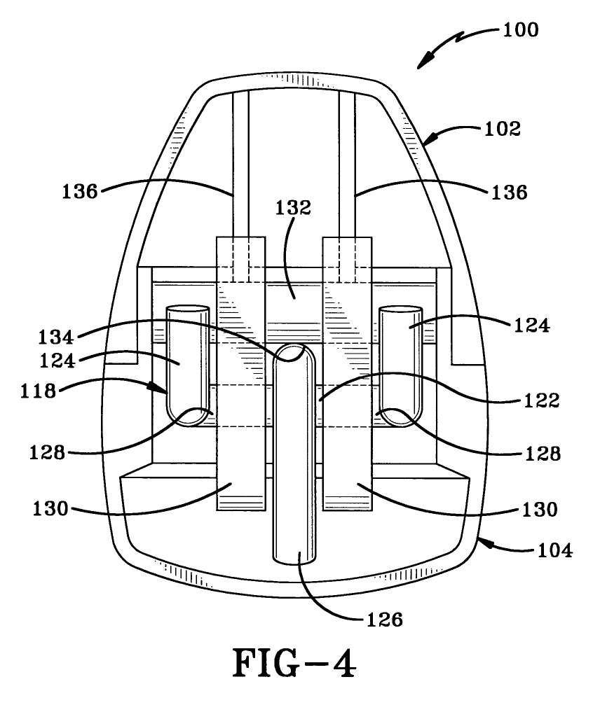

When rod assembly 106 is mounted on support structure 108, space 127 is divided into a pair of spaces 128 (FIG. 4) on either side of finger 126 of rod 116 within lock bar 122. Lower portion 104 of lockable base 100 includes a pair of pivotable arms 130 rotatably mounted on a pivot pin 132. Lower portion 104 further defines a hole 134 to slidably receive rod 116. In a locked position shown in FIG. 3, pivotable arms 130 are disposed in respective spaces 128 and upper portion 102 is lockingly slid downwardly onto lower portion 104 to lock lockable base 100 so that it may not be moved outwardly from support structure 108, thus preventing the removal of rod assembly 106 with items of merchandise 110 thereon. A stop 136 is located within the upper portion of chamber 125 within upper portion 102 and engages pivot rod 132 (FIG. 3) when the base is in the locked position.

In operation, lockable base 100 functions as follows. Lower portion 104 is moved inwardly toward support structure 108 in an direction shown by Arrow A in FIG. 2 with pivotable arms 130 extending in a somewhat horizontal direction toward support structure 108. Arms 130 rotate about pivot pin 132 in the direction shown by Arrow B and begin moving into respective spaces 128. FIG. 3 shows arms 130 fully rotated to a vertical position and disposed in respective spaces 128, thus creating an interference with lock bar 122 of hook 118 to prevent outward movement of the display hook from support structure 108 when upper portion 102 is locked into place onto lower portion 104. A reverse rotation of arms 130 about pivot pin 132 is prevented by stop 136 of upper portion 102. Upper portion 102 is locked to lower portion 104 by any suitable locking mechanism, for example, the locking mechanism shown in the third embodiment in FIG. 10, as later described, and may be unlocked by a key (not shown).

Lockable base 200 of the second embodiment is shown in FIGS. 5-8 and is in the form of a clam shell assembly with an upper portion 202 rotatably connected to a lower portion 204 at a pivot 205. The support structure and rod assembly used with this second embodiment are the same as the first embodiment and are numbered the same, including spaces 127, 128 formed within the interior of lock bar 122 of hook 118. Lower portion 204 defines an interior chamber 230 and includes a pair of spaced ribs 232 extending upwardly therein and beyond the upper portion of interior chamber 230. Lower portion 204 also includes a latching arm 234 extending upwardly from within interior chamber 230 and above chamber 230. Lower portion 204 further defines a U-shaped slot 235 disposed between ribs 232. Upper portion 202 defines an interior chamber 236 that includes a pair of spaced ribs 238 extending downwardly from within chamber 236 and below the lower bounds of chamber 236. Upper portion 202 further defines a U-shaped slot 240 disposed between ribs 238. Ribs 238 are spaced apart from one another a greater distance than are ribs 232. Upper portion 202 further defines a catch 242 disposed within interior chamber 236.

In operation, lockable base 200 is disposed adjacent the inner end of rod assembly 106 with one of U-shaped slots 240 or 235 disposed around rod 116. While either lower portion 202 or 204 may be positioned first, FIG. 5 shows upper portion 202 being put in place first whereby rods 116 is disposed in slot 240 and ribs 238 are disposed in respective spaces 128 (FIG. 8) in the interior of lock bar 122 of hook 118. Subsequently, lower portion 204 is rotated about pivot 205 in a direction shown by Arrow C toward a closed and locked position. FIGS. 6-8 show lockable base 200 in the locked position. As seen in FIG. 8, ribs 232 are disposed within respective spaces 128 between intermediate finger 126 of rod 116 and respective ribs 238 of upper portion 202. In addition, finger 234 lockingly engages latch 242 to hold lower portion 204 to upper portion 202. Ribs 232 and 238 thus provide an interference with lock bar 122 of hook 118 to prevent movement of lockable base 200 outwardly from support structure 108 and the removal of the display hook. Alternately, lockable base 200 may be configured without pivot 205 and the related structure which allows a pivotable engagement between lower portion 204 into upper portion 202. In such an embodiment, an upper and lower portion would simply slide with respect to one another and may include an additional latching finger and catch to hold the respective portions together. Lockable base 200 may be unlocked by a key (not shown) and may include different locking mechanisms such as the one shown in FIG. 10 of the third embodiment. Otherwise, such an embodiment would work in the same manner as lockable base 200.

Lockable base 300 of the third embodiment (FIGS. 9-11) includes an upper portion 302 and a lower portion 304 and is used with an altered rod assembly 306 whereby a rod 316 includes a smaller diameter portion 315 bounded by a ledge 317 outwardly of smaller diameter portion 315. Otherwise rod assembly 306 is the same as rod assembly 106, including the hook thereof. Therefore, the hook is numbered as in the previous embodiments. Upper section 302 includes an upper wall 330 and a lower insertable wall 332 which is stepped inwardly from wall 330, the two walls together defining an interior chamber 334. Upper portion 302 further defines an elongated slot 336 which extends through wall 332 and into wall 330. Slot 336 is configured to slidably receive smaller diameter portion 315 of rod 316. Lower portion 304 includes a wall 338 comprising an outer wall portion 340, a lower wall portion 342 and a pair of spaced sidewall portions 344. Wall 338 defines an interior chamber 346. With reference to FIG. 10, one sidewall portion 344 defines an elongated depression 348 in which is disposed a base 350 of a locking finger assembly 352. Insertable wall 332 of upper portion 302 defines a depression 354 having a ledge 356 at the lower end thereof. Locking finger assembly 352 further includes a locking finger 358 which is disposed in depression 354 of insertable wall 332 when lockable base 300 is in a locked position, as shown in FIG. 10.

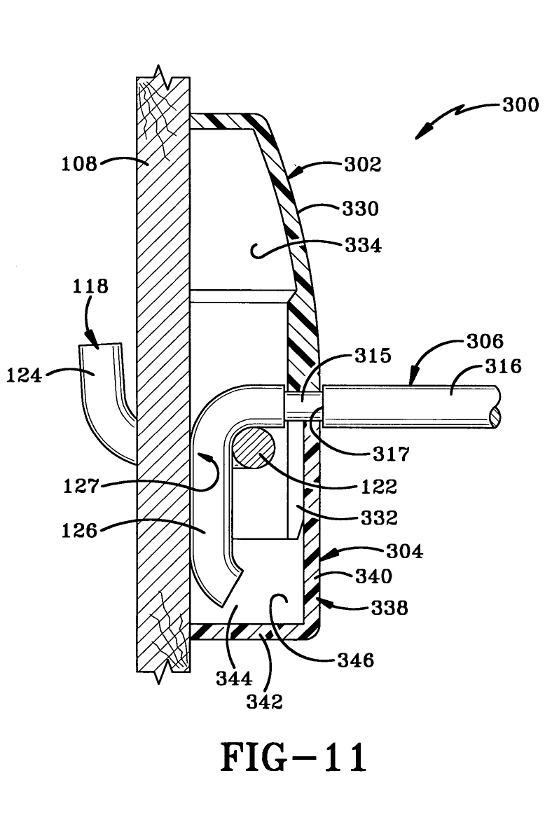

In operation, upper portion 302 is moved so that small diameter portion 315 of rod 316 is slidably received within slot 336. Then lower portion 304 is slid upwardly in a direction indicated at Arrow C in FIG. 9 so that interior chamber 346 of lower portion 304 slidably receives insert wall 332 of upper portion 302 to attain a closed and locked position as shown in FIGS. 10-11. As most easily seen in FIG. 11, the outer surface of wall 330 of upper portion 302 is disposed closely adjacent ledge 317 on rod 316. Likewise, the outer surface of outer wall portion 340 of lower portion 304 is disposed closely adjacent ledge 317. In this position, interference is created between walls 330 and ledge 317 as well as between wall portion 340 and ledge 317 when an attempt is made to move lockable base 300 outwardly from support structure 108. As seen in FIG. 10, spring finger 358 is disposed in depression 354 with a lower end of finger 358 being disposed closely adjacent or abutting ledge 356 of insertable wall 332. In this locked position, ledge 356 and finger 358 create an interference to prevent the downward movement of lower portion 304, thus preventing the removal of lower portion 304 from upper portion 302. As easily discerned, the locked position is achieved as the lower tip of insertable wall 332 slides into interior chamber 346 and pushes spring finger 358 outwardly in order to pass beyond finger 358 and subsequently allow finger 358 to spring inwardly into depression 354 to provide the locked position. Locking assembly 352 is susceptible to magnetic attraction whereby it can be unlocked by a magnetic key (not shown) when placed in close proximity thereto. As with the other embodiments, any simple locking mechanism to prevent portions 302 and 304 from being separated may be used without departing from the spirit of the invention.

As shown and described, each of lockable bases 100, 200 and 300 provides a locking mechanism to prevent the removal of a rod assembly 106 or 306 from the support structure 108, thus providing an effective means to prevent shoplifting by the method of removing an entire display hook from support structure 108.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A lockable base for locking a merchandise display rod assembly to a support structure, the rod assembly having a rod adapted to extend outwardly from the support structure when mounted thereon and a hook attachable to the support structure and having a lock bar engageable with a portion of the rod for mounting the rod on the support structure; the lockable base comprising first and second components securable together in a locked position and forming an interior chamber, said lock bar and engageable portion of the rod being located within the interior chamber and inaccessible by unauthorized personnel by the first and second components when in the locked position.

2. The lockable base defined in claim 1 wherein the lockable base includes a pair of pivotable arms which pivot between a first position external to a pair of spaces formed outwardly of the support structure and between the portion of the rod in the interior chamber and spaced legs of the lock bar, and a second position in which the arms are partially disposed respectively in the pair of spaces.

3. The lockable base defined in claim 2 wherein the pivotable arms are mounted on one of the portions; and a stop is mounted on the other of the portions to prevent rotation of the pivotable arms when the portions are in the locked position.

4. The lockable base defined in claim 2 wherein a space is formed between the lock hook and support structure for receiving the portion of the rod therein; and in which the first portion of the lockable base includes at least one rigid rib which in the locked position is disposed in said space.

5. The lockable base defined in claim 4 wherein the first portion includes a pair of rigid ribs disposed in the space between the support structure and lock hook.

6. The lockable base defined in claim 2 wherein the pair of pivotable arms are formed integrally with a pivot pin mounted on the first portion.

7. The lockable base defined in claim 1 further including a locking mechanism to lock the first portion to the second portion.

8. The lockable base defined in claim 1 wherein the first and second portions are pivotally connected together.

9. The lockable base defined in claim 1 wherein the first and second portions are slidably inserted together.

10. The lockable base defined in claim 9 wherein an aperture is formed in the first portion for slidably receiving a second portion of the rod therein, said second rod portion forming a stop engageable with the first portion of the lockable base to prevent removal of the rod assembly from the support structure.

11. The lockable base defined in claim 10 wherein the aperture is an elongated slot; and in which the second portion of the rod is a reduced diameter portion of said rod.

12. The lockable base defined in claim 1 including a magnetically operable locking mechanism to lock the first portion of the lockable base to the second portion of said base.

13. The lockable base defined in claim 11 wherein the locking mechanism includes a spring biased finger mounted on one of the lockable base portions and a ledge formed on the other of said portions engageable with the finger when the base is in the locked position.

14. The lockable base defined in claim 1 wherein the rod has a bent end which is the portion of the rod engageable with the lock bar.

15. In combination, a display board, a display rod assembly for displaying items of merchandise thereon, and a lockable base for locking the display rod assembly on the display board; the rod assembly having a rod extending outwardly from the display board and a hook attachable to the display board and having a lock bar engageable with a bent end portion of the rod for mounting the rod on the display board; the lockable base comprising first and second components securable together in a locked position and forming an interior chamber, said lock bar and end portion of the rod being located within the interior chamber and inaccessible by unauthorized personnel when the first and second components are in the locked position.

16. The combination defined in claim 15 wherein the lockable base includes a pair of pivotable arms which pivot between a first position external to a space formed between the display board and the lock bar of the hook, and a second position in which the arms are partially disposed in the space to prevent removal of the rod assembly when in the locked position.

17. The combination defined in claim 16 wherein the pivotable arms are mounted on one of the components and a stop is mounted on the other of the components to prevent rotation of the pivotable arms when the components are in the locked position.

18. The combination defined in claim 16 wherein the pivotable arms are incorporated into the first component; and in which at least one rigid rib is formed on the second component and is disposed in the space between the lock bar and display board when in the locked position.

19. The combination defined in claim 15 including a magnetically activated locking mechanism to lock the first component to the second component.

20. The combination defined in claim 15 wherein the first and second components are pivotally connected together.

21. The combination defined in claim 15 wherein the first and second components are slidably inserted together.

22. The combination defined in claim 21 wherein an aperture is formed in the first component for slidably receiving a second portion of the rod therein, said second portion forming a stop engageable with the first component to prevent removal of the rod assembly from the support structure.

23. The combination defined in claim 22 wherein the aperture is an elongated slot; and in which the second portion of the rod is a reduced diameter portion of said rod.
